(19) United States
(12) Patent Application Publication
(10) Pub. No.: US 2007/0062084 A1
(43) Pub. Date: Mar. 22, 2007

(54) True color day-night graphics system and method of assembly

(76) Inventor: Stephen P. Rosa, Reno, NV (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/507,643

(22) Filed: Aug. 22, 2006

Related U.S. Application Data
(60) Provisional application No. 60/709,818, filed on Aug. 22, 2005.

(51) Int. Cl. G09F 13/22

(52) U.S. Cl. 40/544

(57) ABSTRACT

The graphics display of U.S. Pat. No. 5,518,561 is modified by selectively actuating surface-conforming illumination layers positioned behind graphics and in response to external conditions and from a variety of sources. The external conditions include time, weather and, when the display is mounted on a vehicle, the vehicle location. Selective actuation of different sections of the display permit controlled changes in the display and special effects.

### CROSS REFERENCE TO RELATED APPLICATION

This application claims priority from U.S. Provisional Patent Application Ser. No. 60/709,818, entitled “Improved True Color Day-Night Graphics System and Method of Assembly” filed Aug. 22, 2005. The disclosure in that provisional patent application is incorporated herein by reference in its entirety.

The present invention is an improvement of the invention described in my U.S. Pat. No. 5,518,561, issued May 21, 1996 and entitled “True-Color Day Night Graphics and Method of Assembly”. The entire disclosure in that patent is expressly incorporated by reference.

### FIELD OF THE INVENTION

The present invention pertains to graphic displays and, more particularly, to a conformable true color graphic display in which portions or all of the display can be selectively rendered visible by either or both front and back lighting, and wherein individual segments of the display are selectively back-lighted or masked in response to control signals generated locally or remotely, automatically and/or manually, to adapt the display to differing conditions.

### BACKGROUND

The advertising industry is in a state of flux as clients look for methods to target niche audiences with well-timed eye-catching messages and product placements. Established media channels (e.g., network TV, print newspapers, broadcast radio, etc) no longer deliver the results advertisers have come to rely upon. A number of reasons have been offered for these diminished results, including the impact of TiVO (i.e., people can edit out commercials), the emergence of satellite radio (i.e., people pay not to hear commercials), and the raised expectations of interactivity brought on by the widespread use of the Internet. The ability to control what they see and absorb is now the rule rather than the exception among American consumers.

At the same time, the number of cars on the road and the level of congestion around major US cities have increased the average commute time for American workers. Outdoor advertising, which includes billboards, transit furniture, building wraps, and truckside advertising, reaches these same commuters, drivers, pedestrians, etc., as they move around before, during and after work. Outdoor advertising is actually growing in importance to the companies and organizations desiring to get their messages across.

Discussion of Prior Art

U.S. Pat. No. 6,690,286 (Polyakov) discloses a system of advertising designed to transmit variable advertising information to be displayed in different “zones” in order to address the demographics of the particular “zone” in which the vehicle is located. The Polyakov system relies on a central information producing server that transmits advertising content information to a special purpose receiver on board a vehicle (or vehicles) via some kind of wireless arrangement. The server sends the information to be displayed in response to a signal that the vehicle transmits to the central control station where the server is located telling the server of the current location of the vehicle. Hence, the server is the central feature in the Polyakov system. There is no onboard (i.e., at the vehicle) autonomous control capability and this is disadvantageous for many reasons. For example, operating a wireless communications network that is capable of transmitting rich media content requires significant bandwidth. Bandwidth is expensive, and the problem of transmitting wide bandwidth signal to moving vehicles on a reliable basis is not susceptible to trivial solution. Cell phones now can send and receive rich media content (via multi-media messaging service format, or MMS) such as photos and videos, but these are for display on small screens and the transmission times are noticeably slow. The logos and true color graphics presented in truckside advertising are large (a typical trailer is 8′×40′) and very high definition images. No sponsor or fleet owner would accept discernable pixilation or distortion in their outdoor advertising. Thus, the bandwidth required to transmit this rich media signal in real time with the resolution required for truckside advertising would be beyond the practical capability of current commercial communications networks, making the Polyakov system impractical for the outdoor advertising applications relevant to the present invention.

Moving vehicles traveling in urban, semi-urban and otherwise built up areas run into all manner of wireless communications challenges, from line-of-sight blockages to interference from other transmitters in the area. Maintaining a constant, reliable wireless link from the server to the moving vehicle(s) is a challenge and cannot be guaranteed. The difficulties this presents from a commercial advertising point of view include:
a. If the signal from the server to the vehicle is lost or interrupted during the time the advertising message is being transmitted, the ability of the vehicle to display the complete message is compromised. Developing a bit error rate (BER) signal corroboration scheme is difficult, and the vehicle may not even know that part of the advertising message was lost, resulting in garbled messages being presented.
b. If the signal from the server to the vehicle is lost or interrupted, the on-vehicle display may not be triggered in the appropriate location or at the appropriate time. If an advertiser has paid to deliver a specific message in Spanish as the vehicle passes through a neighborhood with Latino demographics, and the server-to-vehicle signal is interrupted, the server may not know when the vehicle entered the ‘zone’ (Polyakov's term), the ‘start’ signal may not be received, or a variety of other mis-communications could occur. The result could be the failure to deliver the message, the delivery of the message late, as the vehicle passes into a different ‘zone,’ or some other undesirable outcome.

Further, unless the signal is encrypted or otherwise protected, the use of a wireless signal to deliver an advertising message for display on the vehicles can be problematic. Competitors can intercept, jam, or ‘hack’ the signal to cause the on-vehicle display to do nothing, or worse. The problem of hackers trying to capture and distort digital wireless advertising is already a reality, as evidenced by the experience of the large displays in NY City's Times Square and elsewhere.

If the vehicle is moving on a delivery route that travels through undulating countryside, the possibility for signal drop out is also significant. Anyone driving around Pittsburgh and other cities with surrounding hills and mountains can testify to the unreliability of even proven cell phone networks. In these cases, the server-to-vehicle signal will not just be interrupted, it will be blocked altogether.

The Polyakov system also requires having some form of triggering devices pre-positioned in zones to alert the on-vehicle display to operate or change. This is impractical for local courier delivery vehicles which travel different routes each day as determined by the addresses of the deliveries to be made, and also would be very costly to lay out (and obtain FCC signal transmission approval) for large areas or over-the-road semis.

The Polyakov system envisions displaying the digital imagery by some means on a moving vehicle. One could imagine a special vehicle carrying large reverse projection screen systems or flat panel display monitors. Both of these would be totally impractical for commercial vehicles, transit vehicles, building wrap displays or most other forms of outdoor advertising due to cost, reliability, weight and maintenance reasons. In addition, they would make a significant “space claim” on the available carrying space of passenger compartment in a commercial vehicle, forcing the operator to compromise the basic economics of the vehicle. These displays would not be conformal to surfaces or flexible. Additionally, the logos, graphical images and tag lines featured in truckside and other outdoor advertising are large in size because by definition they must be seen and discerned at noticeable distances. The largest digital monitor today is just over one hundred inches measured diagonally, costs tens of thousands of dollars, and is not portable or suitable for outdoor use. The typical logo on the side of a delivery truck far exceeds these dimensions.

### SUMMARY OF THE INVENTION

The present invention builds upon the True Color Day-Night Graphics System disclosed in my prior patent (U.S. Pat. No. 5,518,561) to place conformal high-resolution full color graphics in the field of view of the target audience while the audience members are out of their homes and offices. Specifically, an object of the invention is to integrate a range of electronic switching options and communications interfaces with the conformal high-resolution true color graphics of my prior patent to create a dynamic advertising and promotion system capable of “morphing” or adapting in response to changes in a given situation and/or inputs from observers and controllers.

It is also an object of the invention to add another imagery layer to the display disclosed in my prior patent, the added layer being printed with the full color graphics applied only to the inner face of the substrate. The viewer seeing the truck side with the illuminating layer OFF, would not see these graphic images; however, when external light levels drop and the underlying illumination layer is turned ON, the backlit graphics appear.

The expanded True Color Day-Night Graphics disclosed in my U.S. Pat. No. 5,518,561 patent focuses on ways and means to turn the flexible illumination layer(s) positioned behind the graphics (and masking) layers on and off in response to external conditions, time, and command inputs from a variety of sources. The concept involves backlighting advertising images, logos and other messages attached to the sides of trucks and other mobile platforms so that these graphics can be seen after sunset or in other low light conditions (i.e., fog, overcast clouds, in tunnels, etc.). The impetus behind that invention was the fact that the graphics attached to the sides of the trucks (so-called “truckside advertising”) are otherwise not clearly visible or visible at all in periods of darkness, thus missing an opportunity to reach an additional 40% more impressions per day according to industry sources.

When one considers that the sides of a typical delivery truck in the US are seen by over 16 million viewers a year, the 40% increase in impressions equates to a big audience. The capability provided by the present invention of turning the illumination layer on and off, as part of a pre-planned scheme or in response to events or conditions, makes these graphics even more noticeable.

The total graphic image presented as part of a truckside advertising display or a conformal building wrap presentation may include a number of key elements (i.e., a logo, a product image, a face, etc) as well as large areas of blank or background space. The present invention permits each element within the overall display to have a separate illumination layer positioned behind the graphics. The ability to turn one or more of the illumination layers on and off in some sequence or pattern can simulate movement in the display and enhance the eye-catching impact of the truckside advertising.

The present invention includes all of the elements of the display disclosed in my prior patent and adds a variety of means to control the switching that turns the power to the illumination layer on and off. These include a photo-detector capable of sensing when outside illumination levels drop below some preset value, a Global Positioning Satellite (GPS) system capable of determining the location of the vehicle in a geographic area, a number of radio frequency communications networks that can link the vehicle to a remote central control element located at the truck fleet headquarters or other facility, and a microprocessor with on board memory capable of exploiting inputs from the photo-detector, GPS and other sensors and communications links.

The function of the light level sensing control is straightforward. The amount of external illumination is measured by a photocell or some other electronic form of light detection. A low voltage signal from the detector triggers the power supply to switch on, providing energy to the illumination panel. A detectable increase above the pre-set external illumination level, such as when the vehicle might come out of a tunnel, will cause the photo detector to signal the power to turn off.

This expansion of the invention disclosed in my prior patent frees the truck driver from having to remember to turn on the truckside advertising backlight system and when to do so. As a result, no additional workload is placed on the driver, and the illuminated promotional material is always actuated when desired or as planned.

Incorporating GPS into the invention opens several operating capabilities. The GPS equipment enables the vehicle crew to know the geographic position of the vehicle with an accuracy measured in a few meters or less. This is well within the precision needed to determine the nearest street addresses, for instance. Almost all major trucking companies have fitted their vehicles with GPS tracking systems in order to monitor their status and performance. Using this constantly updated location information in concert with neighborhood demographic data (provided with many commercial GPS products or uploaded from proprietary files onto a small on-board CPU), the present invention determines when to illuminate all or part of a truckside graphic display in response to the specific needs and interests of its changing real time audience.

Another feature of the invention is the addition of another imagery layer that is printed with the full color graphics applied only to the inner face of the substrate, the side directly in contact with the illumination layer and masking layer(s), if any. To the viewer seeing the truck side with the illuminating layer OFF, no image, logo or other message would be apparent. However, when external light levels drop and the underlying illumination layer is turned ON, the backlit graphics appear. A truck side appearing white or other appropriate color during the day reveals vibrant adverting imagery on command at night.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a perspective view of a cargo trailer having a true color day-night graphic display panel according to the present invention mounted on the side.

FIG. 2 is a partially delaminated perspective view of the layered sandwich construction of the true color day-night graphic display panel used in the present invention.

FIG. 3 is a cross-section of an illuminating layer for use in the present invention.

FIG. 4 is a cross-section of an image-carrying substrate with inked graphics in registry on each side.

FIG. 5 is a cross-section of the present invention with a light diffuser interposed between the image-carrying substrate and the illuminating layer.

FIG. 6 is a functional block diagram of the system of the present invention.

### DESCRIPTION OF THE PREFERRED EMBODIMENTS

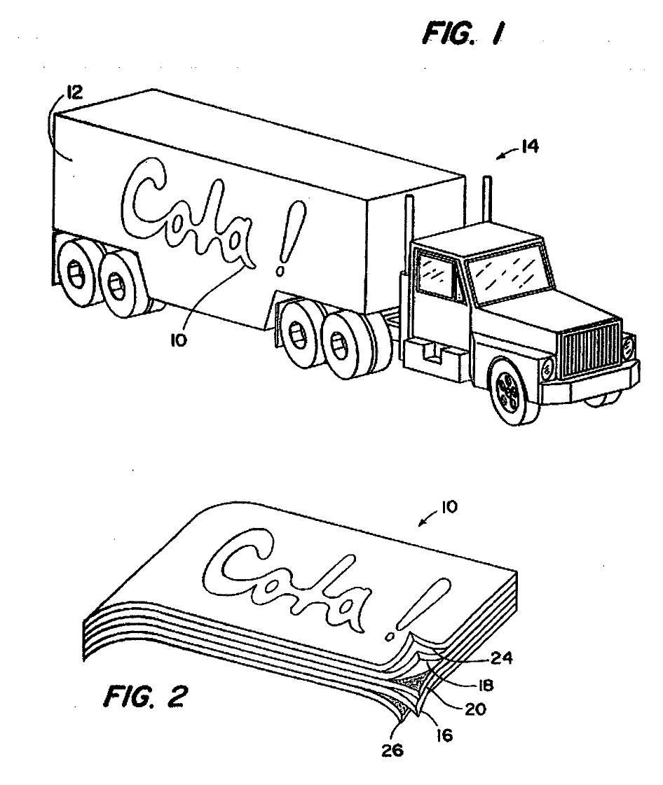

The following detailed explanations of FIG. 1-6 and of the preferred embodiments reveal the methods and apparatus of the present invention.

Referring to FIGS. 1-5, and as described in my U.S. Pat. No. 5,518,561, a true color day-night graphic display panel 10 is shown attached to and flexibly conforming to the side 12 of cargo trailer 14 in FIG. 1. The panel 10 shown in FIG. 2 includes three major elements: a flexible planar layer 16 which, for example, may be similar in characteristics to the lamp disclosed by Dickson et al in U.S. Pat. No. 4,020,389; a translucent image-carrying film-like substrate 18 capable of producing spectrally similar images with front and back illumination as taught by Blake et al in U.S. Pat. No. 5,144,328; and an optically clear flexible adhesive 20, as for instance, marketed by Morgan Adhesives Company of Stow, Ohio under the name PERMATRANS™ IP-2100 to adhere the image-carrying substrate to the lamp. An additional protective layer of weather and wear resistant essentially transparent material 24 can be used to enclose and protect the graphic display panel and conventional means such as a layer of flexible adhesive 26 (e.g., 3M Controltac™ 180 series produced by the 3M Corporation of St. Paul, Minn.) may be used to attach the graphic display to selected support surfaces. It is to be understood that more than one illumination layer, each separately actuable and controlled, may be provided.

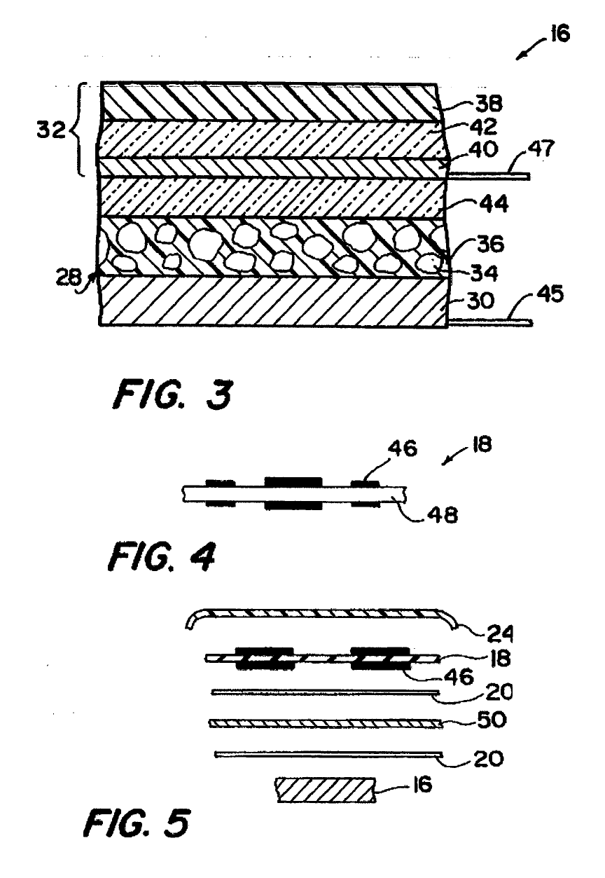

The illuminating layer 16 shown in FIG. 3 may, for example, be of the type disclosed in the aforementioned Dickson et al patent. It may also be an array of light emitting diodes (LEDs), fiber optic mat, or other suitable illumination source(s). Layer 16 preferably has a thin flexible conformable sandwich construction including a layer of illuminating or electroluminescent material 28 bonded between a conventional opaque electrode layer 30 on the opaque side and an essentially transparent electrode layer 32 on the light-emitting side. The illuminating or electroluminescent material can consist of fine particles 34 of an electroluminescent phosphor embedded in a transparent flexible resin 36, LEDs, fiber optics, etc. The transparent electrode layer 32 may be formed of a transparent polymeric substrate 38 of, for example, polyethylene terethphalate, having a high degree of optical transparency, bonded to a metal film 40 sandwiched between layers of high refraction index dielectric films 42 and 44.

Contacts 45 and 47 are fitted to the opaque electrode 30 and the metal thin-film layer 40, respectively, in a conventional manner to energize the lamp with a high frequency alternating current source.

The image-carrying substrate 18 shown in FIG. 4 may, for example, be of the type disclosed in the aforementioned Blake et al patent and has essentially identical inked images 46 deposited in registry on the two sides of a very flexible translucent substrate 48. In practice, the translucent substrate has a transmission factor of approximately 15% and a reflectance of about 85% and may be vinyl material. In an alternative embodiment of the true color day night graphic display, the inked images may be carried in registry on two optically neutral substrates, a translucent substrate and a transparent substrate. The translucent substrate is bonded with optically transparent adhesive to the transparent substrate bonded in turn to the light emitting face of the illuminating panel. The effect is the same. Light from the front of the display is reflected by translucent substrate after twice transmitting the inked images on that surface. Light from the back, emitted by the illuminating layer, passes through the inked images affixed to the transparent substrate and then passes through the inked images on translucent substrate to also reach the observer after being twice affected by passage through the inked images. One or more image-carrying substrates may be provided, and each may be associated with a common illumination panel or respective individually actuable illumination panels to permit selective effectuation of partial or total displays of the various images.

In a further modification the translucent substrate is replaced by a layer of white translucent colorant applied directly over the surface of the transparent substrate and the images inked thereon, again with the same result.

The adhesive 20 must dry essentially transparent, i.e. having an optical clarity of 90% or more, and cannot discolor with age as this would compromise the spectral quality of the graphic images when viewed back lit by the illuminating panel. The transmissivity to white light of the aforementioned PERMATRANS™ IP-2100 is specified as 98% that of laboratory glass but adhesives having lower values of transmissivity could also be used depending on the intensity of the illuminating layer and the brightness requirements of the overall application. In addition, the adhesive must be flexible enough to conform with lamp 16 and substrate 18 to contoured surface applications of the present invention without loss of adhesive bonding properties. Further, the adhesive must not destructively interact with the inked graphics nor penetrate through the substrate. Finally, the adhesive must perform reliably despite constant vibration and fluctuating extremes of temperature and moisture. The PERMATRANS™ IP-2100 product, a thin clear polyester film coated on both sides with clear acrylic pressure sensitive adhesive, and a flowable liquid adhesive marketed by the 3M Corporation of St. Paul, Minn. under the name Scotch-Grip™ 4475, both satisfy the demands of this application.

Achieving optimal color reproduction, in view of variations in the pigmentation of inks and the spectral content of front and back lighting sources, may require some differences in the exact composition and thickness of the images 46 inked essentially in registry. The large scale color graphic systems used to produce outdoor advertising, particularly the computer controlled techniques common in the prior art, are well suited to make such accommodations, and alternative approaches for producing thin film graphics with essentially similar back and front lighting spectral content are envisioned as within the scope of this invention.

All elements 16, 18, 20, 24 and 26 of the display panel 10 are flexible and the panel can be formed to fit and closely follow, or conform to, the contours of any selected surface, for example the recessed, rippled, ribbed, riveted or corrugated sides of rigid sided cargo trailers, train cars and other vehicles, and stationary wall structures. For this purpose the display panel must be capable of bends of at least 90 degrees without destroying the adhesive bonds, reducing the optical transmission characteristics, or destroying light emission characteristics of the illuminating layer. A bending radius of 0.5 inches for a 180 degrees turn, considered a reasonable characteristic for EL panel construction, is fully compatible with this application and both the translucent substrate and transparent adhesive conform to this required level of flexibility. The display panel may be conformably bonded to fabric sidewalls of other such vehicles, or may extend around right angle bends between side and rear walls of a vehicle.

Automatic and/or manual activation of the electric power source, locally or from a remoter location, energizes the illumination layer(s) to back-light the graphic images. Power can be drawn from the vehicle electric system or independently produced by a dedicated generator, storage battery system or solar cell means. When energized by the presence lights or running lights of cargo trailers, the visual effects of such illumination enhances the observability and consequently the highway safety of such vehicles.

Continuous sheet electrodes allow the true color day-night graphic panels to be cut to any desired shape. For example, the illuminating layer may be contoured to back only specific lettering, figures or other features. Moreover, multiple power source circuits may be used to permit various portions of the panels to provide different levels of illumination or even, through conventional circuitry, to provide intermittent or blinking portions for further dramatic effect. As shown in FIG. 5, a sheet of light-diffusing material 50 of various designs, as for instance Lensfilm™, a polymethyl methacrylate blend marketed by the 3M Corporation of St. Paul, Minn., conventional in the art, can be interposed between the illuminating layer 16 and the image carrying substrate 18 to improve the uniformity of illumination over the panel or to reduce the lamp area required to illuminate the image-carrying substrate.

The specific examples for the components described above are by no means limiting, and it is to be understood that any components capable of performing the functions described herein may be substituted for the described components.

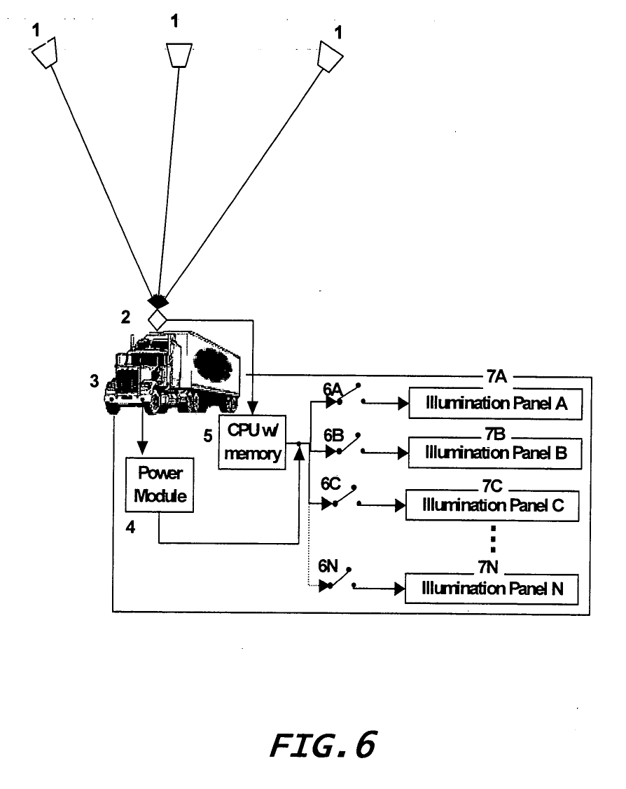

Referring to FIG. 6, advantage is taken of a constellation of Global Positioning Satellites (GPS) 1 orbiting the Earth and now in widespread common use to assist vehicle operators (and other users) to determine their geographic location. The accuracy of the GPS systems commercially available can establish a vehicle's position within ten meters. A GPS receiver 2 is mounted on the truck cab or other suitable vehicle location. Again, there are several suppliers of GPS equipment (Trimble, Garman, etc) that can be substituted interchangeably to physically implement receiver. The vehicle 3 is shown as an 18-wheeler over-the-road tractor-trailer combination, but it is important that any type of delivery vehicle can be utilized, from mini-vans to panel trucks to the large semis.

A power module 4 provides the electrical power for the on board display system. This includes the interface with the vehicle electrical system as well as the harness to the individual illumination panels. There are electrical switches 6a-6N that control the flow of power to each of the illumination panels, and these may be arranged to accommodate any desirable logic switching functions. The switches operate at the direction of the CPU 5. Most vehicles of all types provide auxiliary power outlets, and the trucks used most frequently for delivery operations are so equipped. The power module 4 provides power at the appropriate voltage and current levels to the CPU 5 and the illumination panels 7A-7N.

CPU 5 is the on board computer, with added memory if needed, that receives the location information from the GPS receiver, processes the location data, and determines based on this and other pertinent information (e.g., time of day, driver/operator instructions, etc.) whether or not to turn on or off a particular illumination panel or set of panels. The on board CPU operates by means of closing and opening the electronic switches that are part of the power module and electrical power supply assembly 4. Electrical switches 6A through 6N open or close on command from the CPU 5 and thereby direct electrical power to the individual illumination panels 7. The illumination panels are affixed to the sides and rear of the truck 3 and are conformal and thin and respond to the voltage from the power module 4 in accordance with the commands from the CPU 5.

The power module 4, CPU 5, switches 6, and illumination panels 7 are all on the vehicle itself. The GPS receiver 2 is also attached to the vehicle.

According to one embodiment of the invention, the dynamic truckside advertising morphing or adaptive capability would be fully self-contained on the vehicle. The GPS system, mapping and demographic data, and the microprocessor needed to convert this information into “ON” and “OFF” signals to the illumination panel(s), would all be on the vehicle. Since the graphics are already attached to the skin of the vehicle as described above, the only decision necessary would be when to illuminate which components of the graphics assembly. One can easily envision a delivery truck automatically recognizing when it passes from a neighborhood with a large Latino population into one with Russian language speakers and seeing the message in the truckside advertising first illuminated in Spanish then fade to dark and quickly reappear elsewhere with Cyrillic characters. Images as well as text might be automatically manipulated in this way, so that cultural cautions could be observed and the optimal message presented.

Subtle portions of the daylight message could be made more emphatic later in the evening to reflect the changing demographics of the audience on the street. Advertising messages that might be kept subdued as the vehicle passes through residential or industrial neighborhoods could be brought to light only as the vehicle approaches and enters entertainment districts. Since neighborhood demographics do not change overnight, all of the information and sensing capabilities required to implement this embodiment of the proposed invention would be integral to the vehicle. No external control inputs would be required, minimizing the potential for missed signals and possible errors. Updating the demographic database in the on-board CPU memory could be done periodically or as need arises.

In a second embodiment, the truckside advertising “morphing’ or adaptive capability responds to and is coordinated with input signals received from a central control station. Wireless control signals sent from the central control station to a vehicle fitted with the day-night graphics described above and utilizing the present invention could alter the pre-planned schedule and sequence for powering the illumination layer(s) and/or turn on the illumination layer backlighting in an otherwise hidden or obscured part of the advertising message.

An important aspect of the present invention is the addition of an imagery layer to that described above that is printed with the full color graphics applied only to the inner face of the substrate, the side directly in contact with the illumination layer and masking layer(s), if any. To the viewer seeing the truck side with the illuminating layer OFF, no image, logo or other message would be apparent. However, when external light levels drop and the underlying illumination layer is turned ON, the backlit graphics appear. A truck side appearing white or other appropriate color during the day reveals vibrant adverting imagery on command at night.

Those familiar with these technologies and modern cell phone and wireless communications networks will appreciate that a delivery truck fitted with this embodiment of the proposed invention can be integrated into a real time advertising promotion scheme. Since most delivery vehicles today are integrated into a digital communications network providing real time contact between the driver and dispatcher, the antenna and necessary receiving hardware are already available for further exploitation. The signal to turn the special image or symbol “ON” would involve negligible bandwidth and cost to send.

The central control station can send a signal to change the effect of the message presented on the vehicle. For example, there could be more than one masked portion of the overall day graphic with individual conformal panels behind them. The use of the mask between the backlight illumination panel and the outer day-night graphic layer enables the desired night illumination effect to be very specific (i.e., just the logo in a broader image, an individual face or full figure of a spokesperson or character, the individual words in a message, or some other feature or symbol). Having individual illumination panels behind these specific graphic features permits them to be illuminated at night all at once, individually, or in some pattern, sequence or other arrangement that can be controlled. The ability to communicate with the vehicle means that signals can be sent to the moving vehicle to control, initiate or vary that sequence.

Additionally, once the night portion of the True Color Day-Night Graphics system can be controlled from a central, remote location, the advertising message could be made interactive. Members of the audience seeing the message could contact the central control via cell phone (ubiquitous) or the Internet (from a lap top at a Wi Fi hot spot) to respond to a broader advertising campaign and then have the night portion of the image change in some way or another. For example, a lite beer delivery truck could have a portion of the graphic that is dark (such as a local baseball team logo) light up as people call in to report spotting the truck as it travels its route (the “lite-it-Up” campaign).

Some of the new features incorporated by the present invention into True Color Day-Night Graphics system concept of my prior U.S. Pat. No. 5,518,561 patent include:
1) Adding electronic control to the True Color Day-Night Graphics system.
2) Adding the ability to control individual or multiple portions of the graphic display at night by selectively actuating the surface-conformal backlight panels on command.
3) Adding the ability to send these commands from a remote or central location that is controlling one or more trucks as part of an advertising campaign, with the truck or other vehicle (e.g. bus, subway car, train, etc.) reporting its position automatically (e.g. GPS signal) or manually (e.g. drivers calling in their positions) and the control location modifying the advertising message as conditions (e.g. hour of the night, demographics, etc.), location or other circumstances change.
4) Adding further the ability to have the central control station respond to inputs from the viewing audience sent in by phone or internet and change the message in response to these inputs (e.g., have the image form letters and/or numbers that can change much like the old displays on calculators, so that messages could be spelled out, votes tallied, etc).
5) Adding further the ability to mount these surface-conformal True Color Day-Night Graphics systems with variable controlled messages on the sides of buildings that may not be flat. For example, oil storage and water tanks, grain silos, smokestacks, and irregularly shaped billboards.

The invention can be effected in a variety of ways, with digital and analog controls, and respond to signals sent through a number of different communications media. The change of the image can also be set to operate in accordance with a preprogrammed pattern (a default mode) until some other signal changes the sequence. The default mode could operate if the vehicle is out of signal range from the central control unit.

Alternatively, the vehicle can have an on-board controller that automatically responds to GPS location changes; or the driver can change the message in route as the vehicle travels the delivery route.

Having described preferred embodiments of new and improved color day-night graphics system and method of assembly, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1) A method for producing conformable and flexible true color day-night graphic displays for conformable attachment to the predetermined topographical features forming the exterior of commercial and mass transit vehicles, transit furniture and other outdoor advertising embodiments with curved, irregular and/or flexible exterior surfaces such as building wraps, said displays having substantially equivalent spectral content when illuminated by a light source located in front of the display as when illuminated by a light source located behind the display, and said displays incorporating control signal responsive means for turning the light source located behind the displays ON and OFF automatically or on command in response to changing ambient lighting conditions and other determinants, said method comprising the steps of:
(a) applying a first set of inked graphic images on the front face of a flexible translucent substrate;
(b) applying a second set of inked graphic images on the back face of said translucent substrate in registry with said first set of inked graphic images;
(c) adhering said back face of said translucent substrate to the light-emitting face of an illumination layer such as an electroluminescent panel, flat panel light emitting diode array, fiber optic mat or other flexible light source with a durable conformable essentially transparent adhesive material to form a substrate-panel assembly;
(d) adhering the non-light emitting face of said illuminating layer to said vehicle side such that said substrate-panel assembly conforms to the topographical features of the commercial or mass transit vehicle or other outdoor advertising support surface; and
(e) applying electrical energy to energize said illumination layer using an electrical circuit containing a switch that can be selectively turned ON and OFF manually and/or automatically in response to control inputs emanating from an onboard sensor or central processing unit.

2) The method of claim 1 further comprising adding a flexible, surface-conformable optically opaque layer between the flexible translucent layer and the illuminating layer for selectively and precisely masking the illuminating layer from backlighting portions of the translucent layer.

3) The method of claim 1 wherein step (e) includes providing an onboard or co-located photo detector or other light level detection means for issuing a signal to the switch in the electrical circuit to turn the power to the illuminating layer ON when the external light levels drop below some pre-set level.

4) The method of claim 1 wherein step (e) includes providing on board global positioning satellite system circuitry or other position location means for issuing a signal to the switch in the electrical circuit to turn the power to the illuminating layer ON or OFF when the vehicle is determined to be at some geographic location or conversely has left some geographic location.

5) The method of claim 1 wherein step (e) includes providing an onboard or co-located clock that issues a signal to the switch in the electrical circuit to turn the power to the illuminating layer ON and/or OFF according to a pre-set schedule.

6) The method of claim 1 wherein step (e) includes providing an onboard or co-located microprocessor capable of receiving and analyzing inputs from a variety of sensors such as photo detectors, GPS units, clocks, and, in issue a signal to the switches in the electrical circuit to turn the power to the illuminating layers ON and/or OFF as appropriate.

7) The method of claim 1 wherein step (e) includes providing an onboard or co-located wireless communications link to send information regarding the status (ON or OFF) of the conformable true color day/night graphic display(s) and the carrier vehicle (location, ambient light conditions, etc) to a microprocessor located remotely where said microprocessor receives and analyzes these inputs and, in accordance with a pre-programmed logic, issues a signal to the switches in the electrical circuit of the invention to turn the power to the illuminating layers ON and/or OFF as appropriate.

8) The method of claim 5 wherein step (e) includes providing an onboard or collocated wireless communications link connecting the onboard microprocessor to one or more digital networks allowing these networks to send inputs to said microprocessor where said microprocessor receives and analyses these inputs and, in accordance with a pre-programmed logic, issues a signal to the switches in the electrical circuit of the invention to turn the power to the illuminating layers ON and/or OFF as appropriate.

9) The method of claim 6 wherein the electrical switches provide status information such as ON, OFF, power flowing, to the remotely located microprocessor via the wireless communications link as positive feedback control of the system.

10) The method of claim 7 wherein the electrical switches provide status information such as ON, OFF, power flowing, to the onboard or co-located microprocessor as positive feedback control of the system.

11) The method of claim 1 further comprising encasing the illuminating layer in a sleeve attached to the back face of said translucent substrate so that the illuminating layer can be easily removed as necessary for maintenance or repair, and forming said sleeve of suitably surface-conformable material so as not to limit the conformability or flexibility of the resulting assembly.

12) The method of claim 10 further comprising inserting two illuminating layers in the sleeve with the non-illuminating sides back-to-back so as to provide illumination in opposite directions, and wherein step (a) includes sandwiching two translucent substrates having substantially identical inked images on the front faces of said translucent substrates, bonded or sewn together with the sleeve containing the two illuminating layers positioned fast between them to form a flexible banner or flag capable of producing true color day night graphics when viewed from either side, draped over an object or attached as an advertisement to an aircraft of some form.

13) The method of claim 1 wherein, in step (a) there is no inked image on the front face of the flexible translucent layer and the inked image is only on the back face so that in daylight, the casual viewer will see no image and only when the illuminating layer is turned ON does the inked image become detectable.

14) The method of claim 1 further comprising providing a blank outer layer on said display.

15) A surface-conformable and flexible true color day-night graphic display for conformable attachment to irregular or curved topographical features of a mounting surface said display having substantially equivalent spectral content when illuminated by a light source located in front of the display as when illuminated by a light source located behind the display, and said display incorporating control signal responsive means for turning the light source located behind the displays ON and OFF automatically or on command in response to changing ambient lighting conditions and other determinants, said method comprising:
a flexible translucent substrate having a front face and a back face and having a first set of inked graphic images at least on said back face;
an illumination layer having a light-emitting face containing voltage-actuable light source means and a non-light emitting face, said light emitting face adhered to the back face of said translucent substrate with a durable conformable essentially transparent adhesive material to form a substrate-panel assembly;
wherein the non-light emitting face of said illuminating layer is adapted to be adhered to said mounting surface such that said substrate-panel assembly conforms to the topographical features of the mounting surface;
an electrical circuit containing actuable switch means for selectively applying actuation voltage to actuate said light source means manually and/or automatically;
control means for selectively actuating said switch means to control selective portions of said light source means.

16) The display of claim 15 wherein said first set of inked graphic images can be viewed from in front of said display only when said illumination layer is actuated.

17) The display of claim 15 wherein said mounting surface is the side of a motor vehicle.

18) The display of claim 17 wherein said control means is located remotely from and in through-the-air signal communication with said vehicle, and wherein said control means includes means for transmitting signals to said vehicle to effect actuation of said switch means in accordance with different conditions pertaining to time of day and/or location of the vehicle.

19) The display of claim 17 wherein said control means includes vehicle position location sensors for selectively actuating said switch means in accordance with the geographic location of said vehicle.

20) The display of claim 17 wherein said control means includes a CPU located at said vehicle.

21) The display means of claim 20 further comprising a sensor for sensing one or more ambient conditions at said vehicle, and wherein said CPU responds to said one or more ambient conditions selectively actuating said switch means in accordance with the ambient condition changes.

22) The display of claim 20 wherein said control means further includes a server located remotely from and in through-the-air signal communication with said CPU, and wherein said server includes means for transmitting signals to said CPU to effect actuation of said switch means in accordance with different conditions.

23) The display of claim 15 further comprising a second set of inked graphic images on the front face of said flexible translucent substrate in registry with said first set of inked graphic images.
